(19) United States
(12) Patent Application Publication
(10) Pub. No.: US 2024/0257157 A1
(43) Pub. Date: Aug. 1, 2024

(54) SYSTEMS AND METHODS FOR EVALUATING ANTI-MONEY LAUNDERING REPORTS

(71) Applicant: ROYAL BANK OF CANADA, Toronto (CA)

(72) Inventors: Adam KATT, Toronto (CA); Bonnie ONG, Toronto (CA); Gurashish Singh SURI, Toronto (CA); Paul BEKOLAY, Toronto (CA)

(21) Appl. No.: 18/428,902

(22) Filed: Jan. 31, 2024

Related U.S. Application Data
(60) Provisional application No. 63/442,254, filed on Jan. 31, 2023.

(51) Int. Cl. G06Q 30/018

(52) U.S. Cl. CPC G06Q 30/0185

(57) ABSTRACT

AML investigative reports are prepared based on detection and investigation of unusual banking transactions and activity. The volume of reports and associated data, and the length of the unstructured narratives make the analysis of the AMLRs difficult. A system and process are described that allows AML reports to be evaluated and the evaluation presented to users. The evaluation of the AMLRs and display of the information users to efficiently generate insights, develop and improve specialized transaction monitoring models; optimize processing streams; perform benchmarking and conduct targeted quality control assessments.

### RELATED APPLICATIONS

The current application claims priority to U.S. Provisional Application 63/442,254 filed Jan. 31, 2023 and entitle “Systems and Methods For Evaluating Anti-Money Laundering Reports,” the entire contents of which are incorporated herein by reference for all purposes.

### TECHNICAL FIELD

The current disclosure relates to analysis of anti-money laundering information and in particular to automated processes for enriching anti-money laundering investigation reports.

### BACKGROUND

For financial institutions, adherence to a comprehensive anti-money laundering (AML) program designed to meet regulatory compliance and prudential risk management responsibilities is mandated by regulatory bodies of the respective countries in which the financial institution operates. Part of the responsibilities of a comprehensive AML program involves adherence to transaction reporting requirements mandated by the national financial intelligence unit. As part of an AML program, reporting entities, such as financial institutions, detect and investigate unusual activity. Upon conclusion of an investigation, reports may be generated which typically include structured information (i.e. transaction and entity/client details) and a written narrative describing the specific transaction(s) or activity.

### SUMMARY

In accordance with the present disclosure there is provided a method of evaluating anti-money laundering reports comprising: retrieving an anti-money laundering report (AMLR) comprising structured AMLR data and unstructured AMLR text data; processing the unstructured AMLR text data using a natural language processor to output an unstructured AMLR text feature vector; predicting a typology of the AMLR using a trained classification model using both the unstructured AMLR text feature vector and the structured AMLR data as input; and predicting a value/risk score of the AMLR from a trained model using the predicted typology, unstructured AMLR text feature vector, and structured AMLR text data as input.

In a further embodiment of the method, the method further comprises: predicting the typology, and value/risk score for a plurality of AMLRs; and generating a graphical user interface displaying a representation of the predicted typology, value and risk score for the plurality of AMLRs.

In a further embodiment of the method, the trained classification model provides an indication of one or more of a plurality of predefined classes that apply to the AMLR.

In a further embodiment of the method, predicting the value/risk score comprises: predicting a value score of the AMLR using a trained value model using the predicted typology, unstructured AMLR text feature vector, and structured AMLR text data as input.; and predicting a risk value of the AMLR using a trained risk model using the predicted typology, unstructured AMLR text feature vector, and structured AMLR text data as input.

In a further embodiment of the method, the trained value model provides a prediction of a value of the AMLR to a plurality of predefined entities.

In a further embodiment of the method, the predefined entities comprise: a value to a bank; a value to society; and an overall value.

In a further embodiment of the method, the trained risk model provides a prediction of a risk of the AMLR to a plurality of predefined risk entities.

In a further embodiment of the method, the predefined risk entities comprise: regulatory; legal; financial; and reputational.

In a further embodiment of the method, the method further comprises training each of: the classification model; the value model; and the risk model.

In a further embodiment of the method, training comprises: retrieving a plurality of AMLRs; presenting each of the AMLRs to an evaluator; for each AMLR, receiving an indication of: a classification of the respective AMLR; a value score of the respective AMLR; and a risk score of the respective AMLR.

In a further embodiment of the method, the indications of the classification of the AMLRs are used to train the classification model.

In a further embodiment of the method, the indications of the value of the AMLRs are used to train the value model.

In a further embodiment of the method, the indications of the risk value of the AMLRs are used to train the risk model.

In accordance with the present disclosure there is further provided a system for use in evaluating anti-money laundering reports, comprising: a processor for executing instructions; and a memory storing instructions which when executed by the processor configure the system to provide a method as described above.

In a further embodiment of the system, the system further comprises: a processing device comprising: a second processor for executing instructions; and a second memory storing instructions which when executed by the processor configure the processor to provide a method comprising: retrieving a plurality of AMLRs; presenting each of the AMLRs to an evaluator; for each AMLR, receiving an indication of: a classification of the respective AMLR; a value score of the respective AMLR; and a risk score of the respective AMLR.

In accordance with the present disclosure there is further provided a non-transitory computer readable medium having instructions stored thereon which when executed by a processor of a computing system configure the system to provide a method as described above.

### BRIEF DESCRIPTION OF THE DRAWINGS

In the accompanying drawings, which illustrate one or more example embodiments:

FIG. 1 depicts a system for use in training components for use in evaluating anti-money laundering reports;

FIG. 2 depicts components of a system for use in evaluating anti-money laundering reports;

FIG. 3 depicts a method of evaluating anti-money laundering reports;

FIG. 4 depicts components of a further system for use in evaluating anti-money laundering reports; and

FIG. 5 depicts a method of evaluating anti-money laundering reports.

### DETAILED DESCRIPTION

Anti-money laundering reports (AMLR) are an important regulatory means by which financial institutions can report suspicious activity and/or transactions to authorities and regulators and take mitigating actions. Understanding the context, importance, and risk of AMLRs is useful for strategic decision making and risk mitigation for both financial institutions, regulators and governments. As described further herein, an AMLR value index or value score and an AMLR risk index or score can be determined from the AMLRs and used to provide insight into the importance of an AMLR in various ways. Further, the assignment of a numerical score to an AMLR addresses the significant manual effort and time required to gain this insight. Current methods require manual assessment of each multi-page report by reading the individual documents to form conclusions on the risk and perceived value of the report.

The AMLR value index and AMLR Risk Index can be calculated for an AMLR. Each may be calculated as a single value that accounts for the value or risk to all interested entities or parties. Alternatively, separate value and risk scores may be determined for different entities. The AMLR value Index attempts to assess the utility of the AMLRs to different entities, and may include an overall value, and value to the bank or financial institution, and a value to society. The value to the bank may reflect specific priorities, risk appetites, regulatory requirements, perceived downstream value and the likelihood of actionable outcomes. The value to society may reflect breadth and severity of human impact, and perceived social trends. While it is possible to calculate separate value scores which may be combined to provide a single risk score. Alternatively, the model used to calculate the value score can be trained to provide a single score that accounts for the value to the various entities.

The AMLR risk index attempts to assess the type of risk posed by the AMLRs. The different types of risks may include for example, legal risk, financial risk, reputational risk and regulatory risk. The utility of the AMLR value index may be assessed with respect to different entities including financial institutions, regulatory bodies, authorities, society, law enforcement and other interested entities. The risk score may calculated individually for the different entities, and possibly combined together into a single score. Alternatively, the model used to calculate the risk score may be calculated as a single score that accounts for the risk to different entities.

Each rating, namely the AMLR value index and AMLR risk index, may each comprise a single numerical score. Alternatively, each rating may comprise a numerical score, for example of between 1 to 4 for each dimension of the ranking. For example, the AMLR value index may comprise a 3 dimensional vector and the AMLR risk index may comprise a 4 dimensional vector. In addition to the value and risk ratings, the analysis may also assign a classification or typology to the AMLR. The processing of the AMLR data presented herein enables various evaluations of AMLRs not previously provided. Insights can be gained through the value and risk ratings and the classification of the group of AMLRs. For example, the analysis may present which classifications are generally high risk high value classifications allowing the financial institution, regulators, governments to for example provide additional resources to addressing or mitigating these types challenges. Additionally, the risk/value ratings of AMLRs may be correlated to the detection event details, such as the detection source and relative frequency, that generated the AMLRs and/or client information such as the client profiles and details collected during the investigative process.

The AMLR value index and AMLR risk index address the challenge of limited insights into AMLR documents due to the significant time and effort required to conduct a manual report-by-report analysis. Currently, AMLRs are unknown to have a consistent index for value or risk. The current models can predict a single score or a number of different scores, based on features for the model. Features relied upon by the models include classification or typology information, word embeddings of unstructured text, as well as other structured elements belonging to the relevant transactions, involved entities/clients, and various details related to the detection and investigation. The AMLR value index and AMLR risk index reduces the effort required to gain insight on the value and risk of an AMLR, while further providing new insight, specifically with respect to the value and risk of an AMLR through a number of dimensions, although other dimensions are possible, overall importance or value; importance or value to the bank; importance or value to society; overall risk, legal risk; financial risk; reputational risk; and regulatory risk.

The current processing algorithm extracts value and risk scores from AMLRs, and uses a classification model such as a random forest classifier, an XGBoost classifier or other type of classification model. An expert application may be used to periodically extract data from AMLRs that can be evaluated by experts to provide value and risk scores as well as classifications. Additionally or alternatively, the expert evaluation can be incorporated into existing business processes instead of by a separate expert application. The information from the expert evaluations can be used to train, validate and continuously monitor and update the models.

The models may use four different sources of data. The first data source is structured data from a case management system that provides data on AML investigations. This source provides historic information describing the nature of the detection event and investigation, such as the source/type and attributes of the referral/detection, the complexity and actions of the investigation, and identified typologies, when available. The second data source is structured data pertaining to the parties and transactions associated with the detection event and investigation, such as type of funds involved and relations to other entities. The third data source is unstructured data from free text in the AMLRs and associated documents. An NLP based model extracts important keywords and bigrams to create a structured data source that is used to infer the typology or type of activity. The determined typology of an AMLR is an important feature in the estimations of risk and value. The fourth data source is data collected from an expert for example using an expert evaluation application. Seasoned investigators are periodically assigned a subset of AMLRs to tag and score using an expert application or other processes, which may be provided in various ways such as a web-based application, a mobile application etc. Participants may be asked to give a typological tag to the AMLR, as well as risk and value scores.

The first three data sources may provide information about the AMLR. In conjunction with the value and risk scores collected from the expert evaluation, it is possible to create an algorithm that can classify and model risk and value for all AMLRs. Periodic collection of expert evaluations is also used to continuously monitor model performance and re-train if necessary.

Models were built to estimate 3 dimensions of importance, i.e. overall value, value to the bank and value to society, and 4 dimensions of risk, i.e. legal risk, financial risk, reputational risk, and regulatory risk, were built and trained and validated using the results of a robust expert tagging exercise. These trained models were used to classify and predict risk and value scores for additional, previously unseen reports. Additionally, risk and value models were built and trained to provide a single score for the risk and values.

The above has described the use of models to predict a risk and value score. Additional models may be trained to assign scores about other information such as a complexity of the AMLR. The typology classification, AMLR value index and AMLR risk index may be used in the development of specialized transaction monitoring models; the identification of cases as candidates for specialized processing streams; the development of predictive features to aid in improving investigative accuracy and efficiency; providing insight bank leadership, regulators and law enforcement; conduct benchmarking and the provide the ability to conduct intelligent quality control assessments.

Further, while the models are trained on the complete data of the AMLR, it is possible to train similar models that rely on less data than the complete AMLR. Such limited data may be available earlier than the complete AMLR and as such the scores may also be prepared earlier. While the scores calculated from the more limited data may not provide as useful of scores, they may still be useful in identifying possible transactions, groups of transactions, accounts, individuals, companies, etc. for further evaluation or inspection.

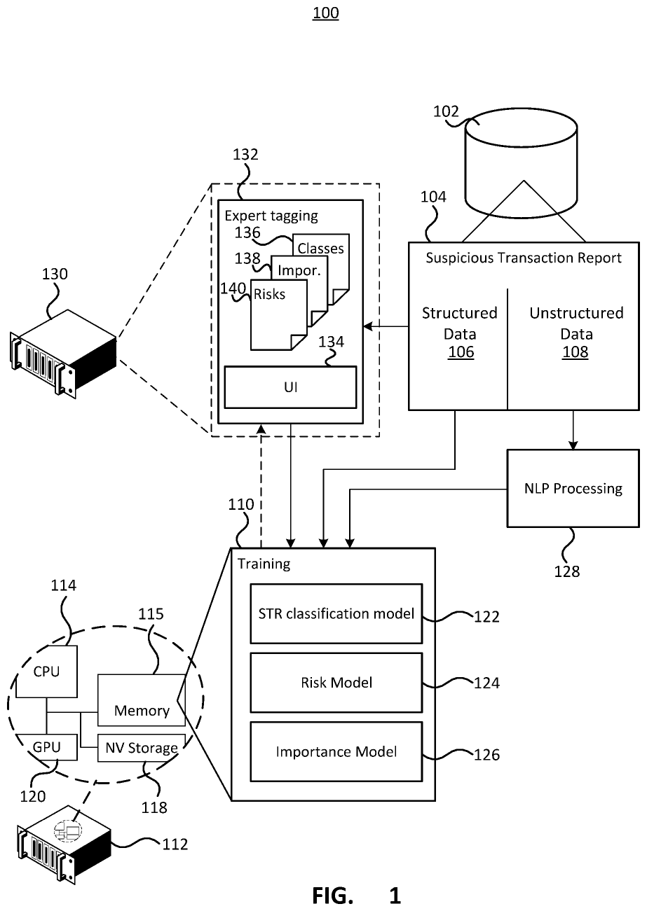

FIG. 1 depicts a system for use in training components for use in evaluating anti-money laundering reports. The system 100 may provide processing of AMLR data stored in a database 102. The AMLR data 104 may comprise both structured data 106 and unstructured data 108. The AMLR data 104 is processed by training data 110 that is provided by one or more processing devices 112.

Each of the computer devices 112 may contain one or more processors or microprocessors, such as a central processing unit (CPU) 144. The CPU 114 performs arithmetic calculations and control functions to execute software stored in a non-transitory internal memory 116, preferably random access memory (RAM) and/or read only memory (ROM), and possibly additional memory 118. The additional memory 118 is non-volatile may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 118 may be physically internal to the computer system, or both.

The one or more processors or microprocessors may comprise any suitable processing unit such as an artificial intelligence (AI) accelerator, programmable logic controller, a microcontroller (which comprises both a processing unit and a non-transitory computer readable medium), system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The computer system 112 may also include other similar means for allowing computer programs or other instructions to be loaded. Such means can include, for example, a communications interface (not shown) which allows software and data to be transferred between the computer system and external systems and networks. Examples of communications interface can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by communications interface. Multiple interfaces, of course, can be provided on a single computer system.

Input and output to and from the computer system may be administered by the input/output (I/O) interface (not shown). The I/O interface may administer control of the display, keyboard, external devices and other such components of the computer system. The computer system may also include a graphical processing unit (GPU) 120. The GPU may also be used for computational purposes as an adjunct to, or instead of, the (CPU) 112, for mathematical calculations.

The various components of the computer system may be coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The memory 116 may store instructions which when executed by the processor 114, and possibly the GPU 120, configure the system 112 to provide various functionality, including training functionality 110. The training functionality 110 may include functionality for training an AMLR classification model 122, a risk prediction model 124; and a value prediction model 126. The training functionality 110 may be trained on information from a plurality of data sources including the structured AMLR data 106 and the unstructured AMLR data 108. The unstructured data 108 may be processed by natural language processing (NLP) functionality 128.

Additionally, the training functionality 110 may use information provided by experts. The experts may use functionality provided by a computing device 130. Although computing device 130 is depicted as a server, the functionality may be provided by other computing devices such as mobile devices, laptops, tablets, etc. The functionality includes expert tagging functionality 132 that may provide a user interface 134 to experts that displays a selection of AMLRs to be evaluated by an expert. The UI 134 may present the expert with options for classifying the AMLR, the dimensions to be evaluated for the importance, and the dimensions to be evaluated for the risks. The options for the classifications 136, importance 138 and risks 140 may be retrieved and presented to the expert. For example, the classification 136 information may comprise one or more classes or categories within a taxonomy of AMLRs. Such an illustrative hierarchical taxonomy is described below. Once trained, the models may be used to evaluate all of the AMLRs, both that are stored and as new ones are created. The hierarchical taxonomy described below is only illustrative and other classification hierarchies may be used with additional or fewer categories as well as different categories.

The collection of all of the AMLR attributes may be considered as a first broad level of the taxonomy. A second level of classes may have classes or categories of “Actions Taken”, “Risk Attributes”, “File Type”, and “Grounds”. Each of these level 2 classes may have further classes and sub-classes as set forth below.

The level 2 “Actions Taken” class can be further categorized as set forth below in Table 1.

TABLE 1

| Level 3 | Level 4 | Level 5 |
|---|---|---|
| Client Actions | Account Freeze | |
| | Cease & Desist | |
| | Client Retained | |
| | Demarket | Technical Demarket |
| | | Partial Demarket |
| | | Full Demarket |
| | Enhanced Due Diligence | |
| | Request Further Information | Insufficient Response |
| | | No Response |
| | | Plausible Explanation |
| Referrals | Internal Referral | |
| | Fraud Referral | |
| | Client Referrals | |
| | Law Enforcement Disclosure | |
| | Peer Disclosure | |
| | Sanctions Referrals | |

The level 2 “Risk Attributes” class can be further categorized as set forth below in Table 2.

TABLE 2

| Level 3 | Level 4 |
|---|---|
| Products & | ACH |
| Channels | Cashiers Cheques/Money Orders/ |
| | Bank Drafts |
| | Cash |
| | Cheques |
| | Cryptocurrency |
| | EFT |
| | EMT |
| | Credit Cards |
| | P2P |
| | Wires |
| Regions | Domestic Only |
| | High Risk Country |
| | International (Non-US) |
| | United States |
| Sectors | Adult Entertainment |
| | Cannabis |
| | Gaming and Casinos |
| | Import/Export |
| | MSB |
| | Oil & Gas |
| | Payment Processing |
| | Real Estate |

The level 2 “File Type” class can be further categorized as set forth below in Table 3.

TABLE 3

| Level 3 | Level 4 | Level 5 |
|---|---|---|
| Administrative | Correction | |
| | Supplementary Material | |
| Intelligence Report | Aggregate Reporting | |
| | Trend Analysis | |
| Ministerial Directive | Adversely Related | |
| Standard | Continuing Activity | Reoccurrence of Point |
| | | Event |
| | | Violation of C&D |
| | Industry STR (Joint) | |
| | Point Event Transaction | |
| Lite | Collection Report | |
| | Initial Awareness Report | |

The level 2 “Grounds” class can be further categorized as a single Level 3 category of “Suspicious Activity” which in turn can be further categorized as set forth below in Table 4.

TABLE 4

| Level 4 | Level 5 | Level 6 | Level 7 |
|---|---|---|---|
| ABAC | Bribery | | |
| | Collusion | | |
| | Embezzlement | | |
| | Grand Corruption | | |
| | Racketeering | | |
| Breach of | Client Code of | | |
| Terms | Conduct | | |
| | Employee Code | | |
| Money | Facilitation | Flow Through | |
| Laundering | Activity | Account | |
| | | Funnel Account | |
| | | Sanctions | |
| | | Evasion | |
| | | Straw Buying | |
| | | Trade Based | Over and Under |
| | | Money | Invoicing |
| | | Laundering | Over and Under |
| | | | Shipping |
| | | | Phantom/Ghost |
| | | | Shipping |
| | | | Multiple |
| | | | Invoicing |
| | | | Parallel |
| | | | Export |
| | | Underground | |
| | | Banking | |
| | Integration | Unknown Source | |
| | | Wealth | |
| | Intentional | questionable | |
| | Obfuscation | or false | |
| | | documentation | |
| | | Refusal of | |
| | | information | |
| | | Structuring | Alters or |
| | | | cancels |
| | | | transactions |
| | | | to Avoiding |
| | | | Reporting |
| | | | Structured |
| | | | Transactions |
| | | | Suspicious |
| | | | Inquiry/ |
| | | | Behavior to |
| | | | Reporting |
| | | | Levels |
| | | Suspicious | |
| | | Use of 3rd | |
| | | Parties | |
| | | Suspicious | |
| | | Use of IVTS | |
| | | suspicious | |
| | | use of | |
| | | multiple | |
| | | accounts | |
| | ML Through | Arbitrage | |
| | Markets | Parking | |
| | Unexplainable | Irrational | |
| | Activity | Transaction | |
| | | Behavior | |
| | | Suspicious | |
| | | designation of | |
| | | beneficiaries | |
| | | Suspicious | |
| | | Exchange of | |
| | | Currencies | |
| | | Suspicious | |
| | | source of funds | |
| | | Suspicious | |
| | | use of noncash | |
| | | monetary | |
| | | instruments | |
| | | transaction | |
| | | out of pattern | |
| | | for customer | |
| | | Unexplainable | |
| | | Bill Exchange | |
| Organized | | | |
| Crime | | | |
| Predicate | Arms | | |
| Offence | Trafficking | | |
| | Child | | |
| | Exploitation | | |
| | | Counterfeit | |
| | | Goods | |
| | Counterfeit or | IPTV | |
| | copyright | Piracy | |
| | Cyber Crime | Click | |
| | | Pharming | |
| | | Cryptojacking | |
| | | Data | |
| | | Harvesting | |
| | | Malware | |
| | | Phishing | |
| | Drug Trafficking | Fentanyl | |
| | Environmental | Wildlife | |
| | Crime | Trafficking | |
| | Extortion | Kidnapping | |
| | | Political | |
| | | Influence | |
| | | Ransomware | |
| | Financial | Abuse of | |
| | Abuse | Vulnerable | |
| | | Persons | |
| | | Elder Abuse | |
| | | Power of | |
| | | Attorney | |
| | | Abuse | |
| | Fraud | Accounts | |
| | | Payable Fraud | |
| | | Booster Payment | |
| | | Cheque Fraud | Altered/ |
| | | | Forged |
| | | | Duplicate |
| | | | Cheque |
| | | | Intended |
| | | | Payee Not |
| | | | Paid |
| | | | Kiting |
| | | | Material |
| | | | Not Paid |
| | | Counterfeiting | |
| | | Credit Fraud | |
| | | Government | Carbon |
| | | Payments | Credits |
| | | Benefits | |
| | | Insurance Fraud | |
| | | Merchant | |
| | | Collusion | |
| | | Mortgage Fraud | |
| | | Ponzi Scheme | |
| | | Scam | Advance Fee |
| | | | Elder Scams |
| | | | Emergency Scam |
| | | | Employment Scam |
| | | | Marketplace Scam |
| | | | Mass Marketing |
| | | | Overpayment |
| | | | Scam |
| | | | Romance |
| | | Unauthorized | ATO |
| | | Use | Email |
| | | | Compromise |
| | | | Identity |
| | | | Theft |
| | | | Impersonation |
| | | | Lost/Stolen |
| | | | Skimming |
| | | Wire/ACH Fraud | |
| | Human | Forced Labour | |
| | Trafficking | Modern Slavery | |
| | | Sex Trafficking | |
| | | Smuggling | |
| | License | Contraband | |
| | Violation | Tobacco | |
| | | Unlicensed | |
| | | Cannabis | |
| | | Unlicensed | |
| | | Gaming/Lottery | |
| | | Unregistered | |
| | | Charity | |
| | | Operation | |
| | Securities | Insider Trading | |
| | Violations | Market | |
| | | Manipulation | |
| | | Unauthorized | |
| | | Pooling | |
| | | Wash Trading | |
| | Tax Evasion | | |
| | Underground | Loan Sharking | |
| | Banking | Hawala(IVTS) | |
| | | Unregistered | |
| | | MSB | |
| Sanctions | Currency | | |
| | Controls | | |
| | Direct | | |
| | Sanctions | | |
| | Exposure | | |
| | Export | | |
| | Controls | | |
| | Indirect | | |
| | Sanctions | | |
| | Exposure | | |
| | Proliferation | | |
| | Sanctions | | |
| | Evasion | | |
| Terrorism/ | Terrorist | | |
| Extremism | Financing | | |
| | Violent | | |
| | Extremism | | |
| | Espionage | | |

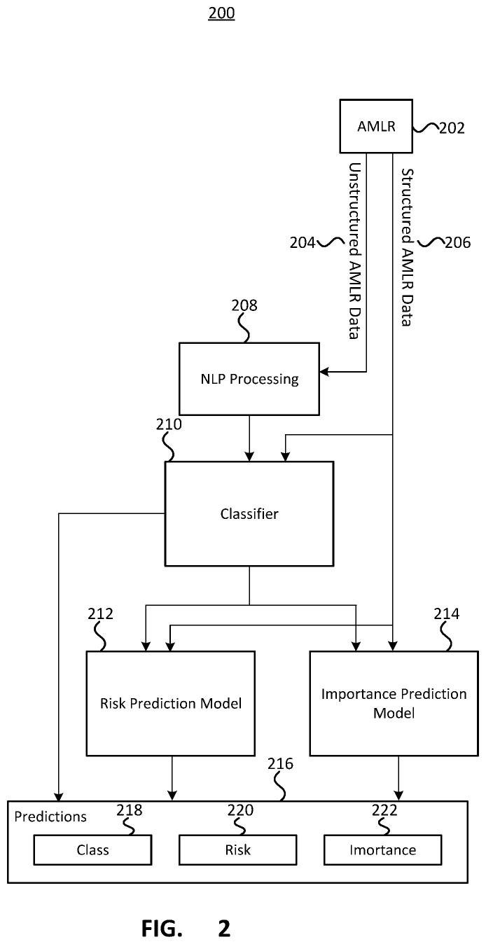

FIG. 2 depicts components of a system for use in evaluating anti-money laundering reports. The system 200 depicts the use of the trained models. Although not depicted in FIG. 2, it will be appreciated that the function components and functionality depicted in FIG. 2 are implemented on a computing device such as that depicted in FIG. 1 for training of the models.

An expert may investigate unusual activity and may create an AMLR 202, which as described above comprises both structured data 206 and unstructured data 204. The unstructured data may be free text written by the expert. The unstructured data 204 may be processed by natural language processing (NLP) functionality 208.

The structured AMLR data 206 and the features from the NLP functionality 210 can be provided to the trained classifier which assigns a class or taxonomy to the AMLRs. The classification information is provided, along with the structured AMLR data 206 to the trained risk prediction model 212 as well as to a value prediction model 214.

The classifier 210 and models 212, 214 process the data and generate predictions 216 of each AMLR. The predictions include a class of the AMLR, if the AMLR did not include a classification, as well as the evaluation along different dimensions for the risk 220 and importance 222 of the AMLR. Although not depicted explicitly in FIG. 2, the predictions 216 may be stored in association with the respective AMLRs.

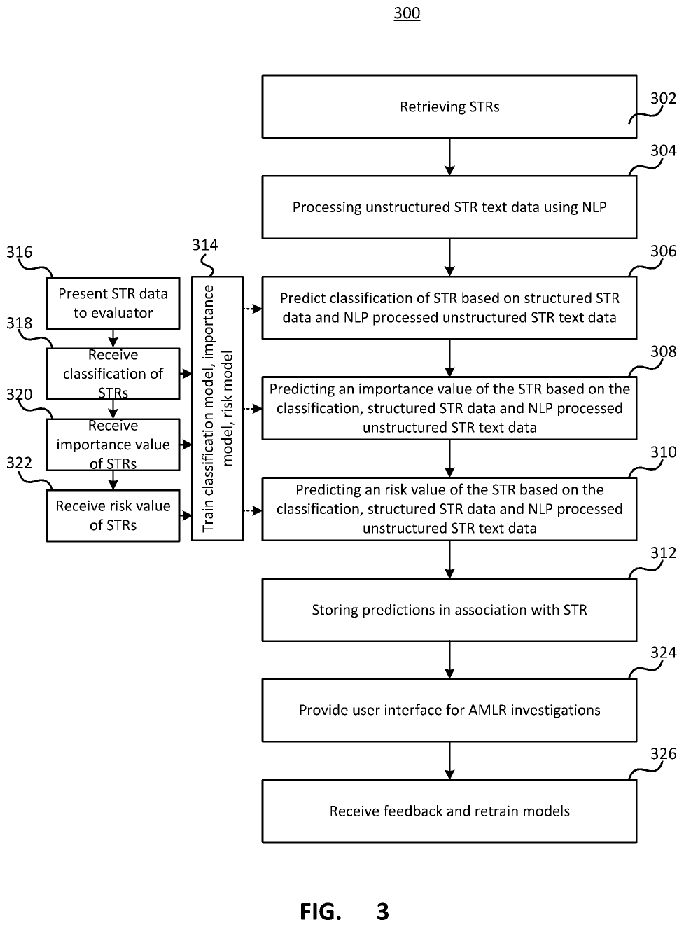

FIG. 3 depicts a method of evaluating anti-money laundering reports. The method 300 may be implemented by one or more computing devices. The method retrieves one or more AMLRs (302) and processed the unstructured text of the AMLR using natural language processing (304). The structured data, as well as the features from the NLP of the unstructured text, can be used to predict a classification of the AMLR (306). The classification prediction as well as the NLP features and the unstructured AMLR data are processed by trained models in order to predict a value score of the AMLR (308) and a risk value of the AMLR (310). The predictions may then be stored (312) in association with the AMLR for subsequent presentation and analysis.

As depicted, the method 300 may include training each of the classification model, the risk model and the value model (314). The training may include presenting the AMLR data to an expert evaluator (316) and then receiving a classification of the AMLR (318), a value score (320) and risk value (322) from the evaluator. The predicted values are used for training the respective models.

With the predicted value and risk scores determined for the AMLRs, a user interface may be provided (324) to allow for further investigation, reviewing of the AMLRs and the predictions, providing feedback on the AMLRs, classifications and predictions, as well as generating reports. Feedback may be provided and used to retrain or update the models (326). For example, an expert may provide their opinion on the classification and/or the risk score and/or the value score which may be used to adjust the models. Additional feedback may be provided for the retraining or updating of the models, which may be determined from other sources. For example, the results of an investigation, such as closing accounts, receiving information requests from authorities, taking no further action, etc. may be determined from an internal case management functionality. The additional information may be used to adjust or retrain models to reflect the actual results.

The above has described processing ASMRs in order to classify the ASMRs and determine a separate value or importance score and a separate risk score. It is possible to train a combined value/risk model to calculate a single value that provides an indication of both the importance and risk the ASMR represents.

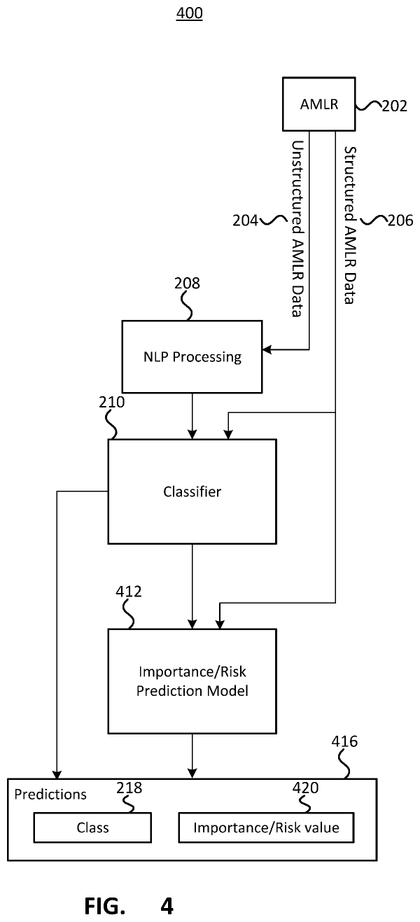

FIG. 4 depicts components of a further system for use in evaluating anti-money laundering reports. The system 400 depicted in FIG. 4 is similar to that described with regard to FIG. 2 with similar components identified using common reference numbers. As described above, an anti-money laundering report (AMLR) 202 is received or retrieved. The AMLR comprises both unstructured AMLR data 204 and structured AMLR data 206. The unstructured AMLR data may first be processed by a natural language processing functionality 208. The NLP processed unstructured data as well as the structured AMLR data can be processed by a trained classifier 210 that can classify the AMLR into one or more classifications. The classification, as well as the NLP processed unstructured data and the structured data can be processed by a combined importance/risk prediction model 412. The importance/risk prediction model 412 is similar to the separate importance prediction model 212 and risk prediction model 214 described above, however the combined model 412 is trained to provide a single score rather than separate scores. As described above, the individual importance and risk models may provide an individual score or may provide a multi-dimensional score. Similarly, the combined importance/risk prediction model 412 may generate a score that is a single dimension or multiple dimensions. The combined importance/risk prediction model 412 may be trained on similar features extracted from the AMLR as used in training both the importance model 212 and the risk model 214 described above. The single value, whether of a single dimension or multiple dimensions, can provide a simpler to interpret evaluation of the AMLR.

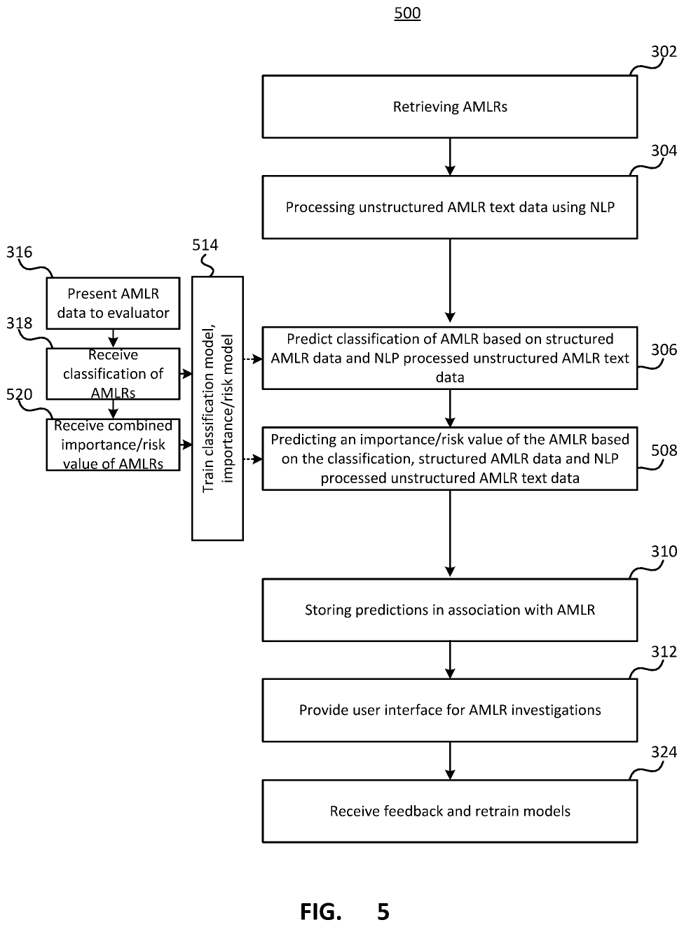

FIG. 5 depicts a method of evaluating anti-money laundering reports. The method 500 is similar to the method 300 described above. The method 500 retrieves one or more AMLRs (302) and processed the unstructured AMLR text data using natural language processing (304). The AMLR data, including both structured data and the NLP-processed unstructured data is processed by a trained classification prediction model to predict a classification of the AMLRs (306). The predicted classification and the AMLR data is applied to a trained combined importance risk value prediction model to generate a combined importance/risk value (508). The predictions from the trained models for the respective AMLRs can be stored in association with the AMLRs (310) and a user interface provided for use in investigating the AMLRs (312).

The classification model and the combined importance/risk model may be trained (514) on a collection of existing AMLR data. The classification model may be trained in substantially the same manner as described above. The combined importance/risk model may be trained using the same features of the AMLR data as used in training the individual importance model and the risk model. The existing AMLRs may be presented to an evaluator (316) that provides what they consider to be the correct classification and the combined importance/risk value of the AMLRs. The classification of the evaluator is received (318) along with the combined importance/risk value and used to train the respective models.

The method may receive feedback and retrain the models using the feedback (326). The feedback may be provided by evaluators or other individuals who have reviewed the AMLR and provided their classification and importance/risk value. Additionally, feedback may be provided from other sources. For example, the outcome of an anti-money laundering investigation can be used as feedback for the importance/risk model.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method of evaluating anti-money laundering reports comprising:
retrieving an anti-money laundering report (AMLR) comprising structured AMLR data and unstructured AMLR text data;
processing the unstructured AMLR text data using a natural language processor to output an unstructured AMLR text feature vector;
predicting a typology of the AMLR using a trained classification model using both the unstructured AMLR text feature vector and the structured AMLR data as input; and
predicting a value/risk score of the AMLR from a trained model using the predicted typology, unstructured AMLR text feature vector, and structured AMLR text data as input.

2. The method of claim 1, further comprising:
predicting the typology, and value/risk score for a plurality of AMLRs; and
generating a graphical user interface displaying a representation of the predicted typology, value and risk score for the plurality of AMLRs.

3. The method of claim 1, wherein the trained classification model provides an indication of one or more of a plurality of predefined classes that apply to the AMLR.

4. The method of claim 1, wherein predicting the value/risk score comprises:
predicting a value score of the AMLR using a trained value model using the predicted typology, unstructured AMLR text feature vector, and structured AMLR text data as input.; and
predicting a risk value of the AMLR using a trained risk model using the predicted typology, unstructured AMLR text feature vector, and structured AMLR text data as input.

5. The method of claim 4, wherein the trained value model provides a prediction of a value of the AMLR to a plurality of predefined entities.

6. The method of claim 5, wherein the predefined entities comprise:
a value to a bank;
a value to society; and
an overall value.

7. The method of claim 4, wherein the trained risk model provides a prediction of a risk of the AMLR to a plurality of predefined risk entities.

8. The method of claim 7, wherein the predefined risk entities comprise:
regulatory;
legal;
financial; and
reputational.

9. The method of claim 4, further comprising training each of:
the classification model;
the value model; and
the risk model.

10. The method of claim 9, wherein training comprises:
retrieving a plurality of AMLRs;
presenting each of the AMLRs to an evaluator;
for each AMLR, receiving an indication of:
a classification of the respective AMLR;
a value score of the respective AMLR; and
a risk score of the respective AMLR.

11. The method of claim 10, wherein the indications of the classification of the AMLRs are used to train the classification model.

12. The method of claim 10, wherein the indications of the value of the AMLRs are used to train the value model.

13. The method of claim 10, wherein the indications of the risk value of the AMLRs are used to train the risk model.

14. A system for use in evaluating anti-money laundering reports, comprising:
a processor for executing instructions; and
a memory storing instructions which when executed by the processor configure the system to provide a method according to claim 1.

15. The system of claim 13, further comprising:
a processing device comprising:
a second processor for executing instructions; and
a second memory storing instructions which when executed by the processor configure the processor to provide a method comprising:
retrieving a plurality of AMLRs;
presenting each of the AMLRs to an evaluator;
for each AMLR, receiving an indication of:
a classification of the respective AMLR;
a value score of the respective AMLR; and
a risk score of the respective AMLR.

16. A non-transitory computer readable medium having instructions stored thereon which when executed by a processor of a computing system configure the system to provide a method according to claim 1.
